(19) United States
(12) Patent Application Publication
(10) Pub. No.: US 2021/0295611 A1
(43) Pub. Date: Sep. 23, 2021

(54) Electronic Game Timer System

(71) Applicant: Daniel Santourian, Palmdale, CA (US)

(72) Inventor: Daniel Santourian, Palmdale, CA (US)

(21) Appl. No.: 16/821,135

(22) Filed: Mar. 17, 2020

(51) Int. Cl. G07C 1/28; G04F 1/00; G04G 15/00; A63F 3/02; A63F 3/00

(52) U.S. Cl. CPC G07C 1/28; G04F 1/005; A63F 2250/1084; A63F 3/02; A63F 3/00151; G04G 15/00

(57) ABSTRACT

A system for tracking the time allotted to and the time spent by a first player and a second player playing a two-person game is provided. The system includes a first and second display for use by the first player and a third and fourth display for use by the second player. The first and fourth displays each display the amount of time remaining for the first player to make his/her moves during the duration of the game, and the second and third displays each display the amount of time remaining for the second player to make his/her moves during the duration of the game. In this way, each player has use of one display that displays his/her remaining time, and one display that displays his/her opponent's remaining time. The system also includes control mechanisms for each player to pause his/her time countdown after his/her turn and to subsequently begin his/her opponent's time countdown at the beginning of his/her opponent's next turn.

### COPYRIGHT STATEMENT

This patent document contains material subject to copyright protection. The copyright owner has no objection to the reproduction of this patent document or any related materials in the files of the United States Patent and Trademark Office, but otherwise reserves all copyrights whatsoever.

### FIELD OF THE INVENTION

This invention relates to two-player games, including chess games and chess game timing systems.

### BACKGROUND

Chess games are often timed in order to place a predetermined time limit on the games and to keep the excitement level high. Most often, chess clocks are used during such games to display the amount of time each player is allotted during the chess game, to keep track of the total amount of time each player takes during his/her turns and to show each player how much time he/she may have left before their time may expire.

The current chess clocks on the market consist of two side-by-side timers (either analogue or digital), with the first timer keeping track of the first player's total time and the second timer keeping track of the second player's total time. The chess clocks also include two pause/start buttons (one used by each player) to pause and/or start the players' respective timers.

The chess clock is placed either to the left side or the right of the chess board with the timer readouts facing inward toward the board, and the player playing the black pieces typically decides on which side to place the clock. During play, it is against the rules to keep a finger on the pause button and/or to hover over it. Accordingly, it is standard playing procedure for each player to use the same hand (e.g., his/her dominant hand) that he/she may use to move the game pieces to also hit the pause button after each move. Given this, if both players use the same dominant hand during play (e.g., their right hands), the player seated with the chess clock to his/her dominant side (e.g., his/her right side) may have a slight advantage in that it may be easier for him/her to hit the pause button after each turn. And given that the player playing black may make this decision, this advantage may typically be enjoyed by this player.

In addition, because the clock readouts may face the gameboard from the side, neither player has a frontal view of the displays (both players must view the clock from their respective side angle) such that it may be difficult to clearly view both clock displays.

Accordingly, there is a need for game playing system that provides clock pause/start buttons to each player in easy to reach positions, and that provides clock displays that may be clearly viewable by each player from the front.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 shows an overview schematic of an electronic game timer system in accordance with exemplary embodiments hereof;

FIG. 2 shows aspects of an electronic game timer system in accordance with exemplary embodiments hereof;

FIG. 3 shows aspects of a readout display in accordance with exemplary embodiments hereof; and

FIG. 4 depicts aspects of computing and computer devices in accordance with exemplary embodiments hereof.

### DETAILED DESCRIPTION OF EXEMPLARY EMBODIMENTS

The term “mechanism,” as used herein, refers to any device(s), process(es), service(s), or combination thereof. A mechanism may be implemented in hardware, software, firmware, using a special-purpose device, or any combination thereof. A mechanism may be mechanical or electrical or a combination thereof. A mechanism may be integrated into a single device or it may be distributed over multiple devices. The various components of a mechanism may be co-located or distributed. The mechanism may be formed from other mechanisms. In general, as used herein, the term “mechanism” may thus be considered shorthand for the term device(s) and/or process(es) and/or service(s).

In general, the system according to exemplary embodiments hereof provides an electronic game play system with various electronic systems, timing mechanisms, readout mechanisms and other types of mechanisms and/or functionalities. In some embodiments, the electronic game play system is used in conjunction with two-person board games such as chess, checkers, backgammon and other types of two-player games. In some embodiments, the game play system is integrated with the game board of the game, while in other embodiments, the game play system may be separate from the game board and/or portable.

For the purpose of this specification and for demonstration, the game play system will be described in relation to its use with the playing of chess. However, it will be understood by a person of ordinary skill in the art, upon reading this specification, that the system may be used with any game that may benefit from the system, and that the scope of the system is not limited in any way by the game with which the system may be used.

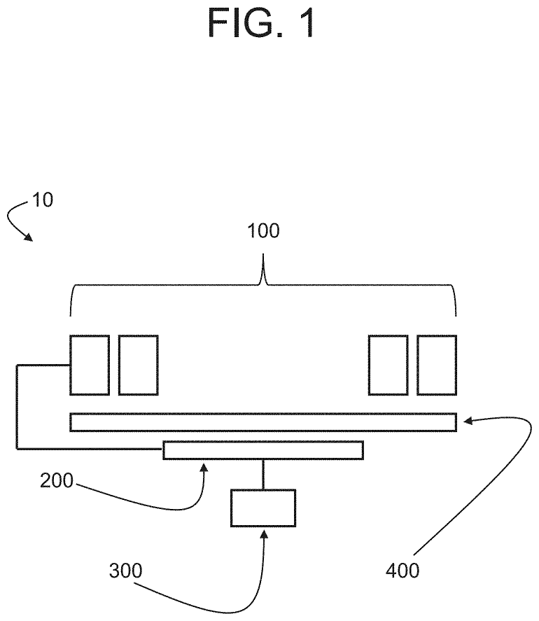

Referring now to FIGS. 1-4, the system 10 according to exemplary embodiments hereof will be described in further detail. In one exemplary embodiment hereof as shown in FIG. 1, the system 10 includes a readout system 100, a timer system 200 and a controller 300. The system 10 also may optionally include a game assembly 400 (e.g., a game board, game table, etc.). The system 10 also may include other elements and/or components that may be necessary for the system 10 to perform its desired functionalities as described in this specification.

For the purposes of this specification and for demonstration, the timer system 200 is shown and described as a system separate from the controller 300. However, it is understood that some or all of the functionalities and/or elements described in relation to the timer system 200 may be performed by and/or included in the controller 300. It is also understood that the timer system 200 may perform all of the necessary control functionalities of the system 10 such that the controller 300 may be optional. It is also understood that the scope of the system 10 includes any combination(s) of any functionalities and/or elements of either the timer system 200 and/or the controller 300.

To provide insight into the system 10 and its benefits, a brief background of some of the elements of the game of chess will be provided below.

In many current implementations of chess, chess clocks are used when the players move in turn. The purpose of a chess clock is to keep track of the total amount of time each player takes for all of his/her moves during a specific game and to ensure that neither player overly delays the game.

For example, it may be decided that a particular game of chess be played over a predetermined amount of time, e.g., 30 minutes. In this example, each player is given 15 minutes of time to make his/her moves during the 30-minute game. The standard chess clock consists of two side-by-side timers (either analogue or digital), with the first timer keeping track of the first player's total time and the second timer keeping track of the second player's total time. The chess clocks also include a set of pause/start buttons (one used by each player) to pause and/or start the players' respective timers.

At the beginning of the game, each player's timer is set to the same predetermined amount of time (e.g., 15 minutes in the above example). For the first player's first turn (the beginning of the game), his/her timer is started and the timer decrements (e.g., in time units of seconds) until the first player (typically the player playing the white pieces) makes his/her move and subsequently hits his/her pause button on the clock. When this happens, the first player's timer is paused, and the second player's timer starts decrementing (e.g., in time units of seconds). The second player (typically the player playing the black pieces) then makes his/her move and subsequently hits his/her pause button to stop his/her timer from decrementing, and to start the decrementing of the first players timer for his/her second turn. This process continues for the duration of the game. If a player runs out of time, he/she loses the game “on time” unless there is checkmate on the board, or the opposing player has insufficient mating material.

The chess clock is placed either to the left or to the right of the chess board with the timer readouts facing inward towards the board. The player playing the black pieces typically decides on which side to place the clock. During play, it is against the rules to keep a finger on the pause button and/or to hover over it. Accordingly, it is standard playing procedure for each player to use the same hand (e.g., his/her dominant hand) that he/she may use to move the game pieces to also hit the pause button after each move. Given this, if both players use the same dominant hand during play (e.g., their right hands), the player seated with the chess clock to his/her dominant side (e.g., his/her right side) may have a slight advantage in that it may be easier for him/her to hit the pause button after each turn. And given that the player playing black may make this decision, this advantage may typically be enjoyed by this player.

Readout System 100

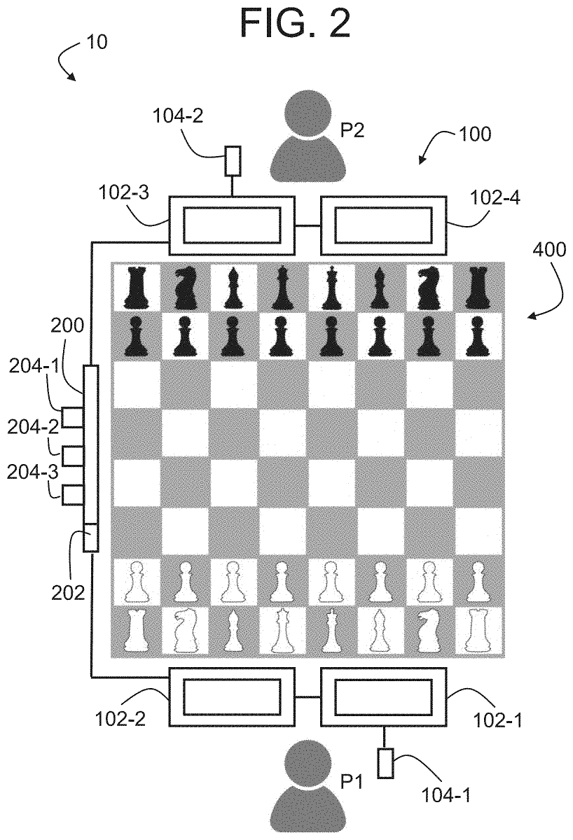

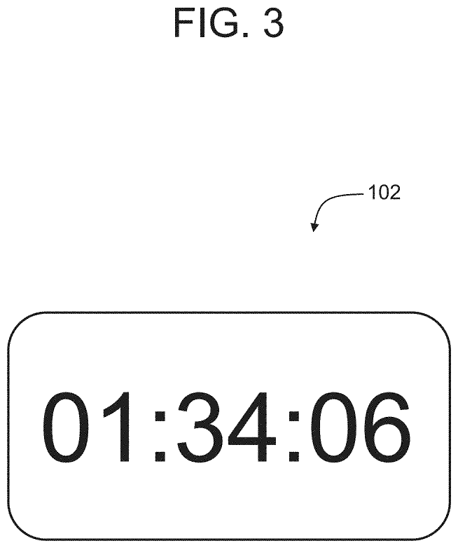

In one exemplary embodiment hereof as shown in FIG. 2, the readout system 100 includes a plurality of readout displays 102-1, 102-2, 102-3, . . . 102-n (collectively and individually 102). In one preferred embodiment, the readout system 100 includes a total of four readout displays 102-1, 102-2, 102-3 and 102-4. Other numbers of readout displays 102 also may be used. As shown in FIG. 3, each readout display 102 may include one or two digits for the hour field, two digits for the minutes field, and two digits for the seconds field. In this way, each readout 102 is able to track and count down time by seconds, minutes and hours.

In some embodiments, two readout displays 102-1, 102-2 are generally positioned for use by the first player P1 and two readout displays 102-3, 102-4 are generally positioned for use by the second player P2. For example, the first player P1 may be positioned to play the white pieces and the second player may be positioned to play the black pieces as shown, and as such, the first and second readout displays 102-1, 102-2 may be positioned on the first player's side and the third and fourth readout displays 102-3, 102-4 may be positioned on the second player's side. In this way, the first player P1 will utilize the first and second readouts 102-1, 102-2 and the second player P2 will utilize the third and fourth readouts 102-3, 102-4 during game play. Note that while the readout displays 102 are shown to be positioned on each respective player's side, the displays 102 may be positioned anywhere with respect to the game board and the players P1, P2, and that the scope of the system 10 is not limited in any way by the position of the readout displays 102.

In some embodiments, the first readout display 102-1 displays the time allotted the first player P1 to make his/her moves during the remaining duration of the game. This may be the display that the first player P1 references regularly during the game to know exactly how much time he/she has left and to strategize accordingly. The second readout display 102-2 displays the time allotted the second player P2 to make his/her moves during the remaining duration of the game. This may be the display that the first player P1 references regularly during the game to know exactly how much time his/her opponent has left and to strategize accordingly. So, in summary, the first and second readouts 102-1, 102-2 are generally used by the first player P1 to understand his/her time constraints and his/her opponent's time constraints during the game.

In some embodiments, the third readout display 102-3 displays the time allotted the second player P2 to make his/her moves during the remaining duration of the game. This may be the display that the second player P2 references regularly during the game to know exactly how much time he/she has left and to strategize accordingly. The fourth readout display 102-4 displays the time allotted the first player P1 to make his/her moves during the remaining duration of the game. This may be the display that the second player P2 references regularly during the game to know exactly how much time his/her opponent has left and to strategize accordingly. So, in summary, the third and fourth readouts 102-3, 102-4 are generally used by the second player P2 to understand his/her time constraints and his/her opponent's time constraints during the game.

Given the above, the first and fourth readout displays 102-1, 102-4 display the amount of time left for the first player P1 to make his/her moves (with the first player P1 viewing the first readout display 102-1 and the second player P2 viewing the fourth readout display 102-4), and the second and third readout displays 102-2, 102-3 display the amount of time left for the second player P2 to make his/her moves (with the second player P2 viewing the third readout display 102-3 and the first player P1 viewing the second readout display 102-2). Accordingly, readout displays 102-1 and 102-4 may generally display identical and/or similar information, and readout displays 102-2 and 102-3 may generally display identical and/or similar information.

Note that while the readout displays 102-1 and 102-2 are depicted as separate units in separate housings, it is understood that the readout displays 102-1 and 102-2 may be combined into a single housing. However, in any event, it is preferable that each readout 102-1, 102-2 be distinct so that each readout's information is easily identifiable and understood. Similarly, readout displays 102-3 and 102-4 also may be combined into a single housing and are preferably distinct.

In one exemplary embodiment hereof as shown in FIG. 2, the readout system 100 includes a plurality of control mechanisms 104-1, 104-2, 104-3, . . . 104-n (collectively and individually 104). In some embodiments, the readout system 100 includes at least one control mechanism 104-1 adapted for use by the first player P1, and at least one control mechanism 104-2 adapted for use by the second player P2. The control mechanisms 104 may include buttons, switches, knobs, levers, other types of control mechanisms and any combination thereof.

The control mechanism 104-1 is activated by the first player P1 during game play when the first player P1 has completed a move during his/her turn and wishes to pause the time decrementing of his/her readout display 102-1 (and 102-4) and begin the time decrementing of his/her opponent's readout display 102-3 (and 102-2). Similarly, the control mechanism 104-2 is activated by the second player P2 during game play when the second player P2 has completed a move during his/her turn and wishes to pause the time decrementing of his/her readout display 102-3 (and 102-2) and begin the time decrementing of his/her opponent's readout display 102-1 (and 102-4).

Accordingly, upon activation of the control mechanism 104-1, the system 10 pauses the time decrementing of the first readout display 102-1 (and simultaneously the fourth readout display 102-4) and begins the time decrementing of the third readout display 102-3 (and simultaneously the second readout display 102-2). Similarly, upon activation of the control mechanism 104-2, the system 10 pauses the time decrementing of the third readout display 102-3 (and simultaneously the second readout display 102-2) and begins the time decrementing of the first readout display 102-1 (and simultaneously the fourth readout display 102-4). In both cases, the decrementing of time may be shown in time units of seconds, tenths of seconds, etc.

In some embodiments, during the duration of the first player's turn, the first control mechanism 104-1 is live (ready to be activated by the first player P1 and to subsequently perform its functionalities as described above), and the second control mechanism 104-2 is offline (any attempts made by the second player P2 to activate the second control mechanism 104-2 during this time does not affect the readout displays 102). Similarly, during the duration of the second player's turn, the second control mechanism 104-2 is live (ready to be activated by the second player P2 and to subsequently perform its functionalities as described above), and the first control mechanism 104-1 is offline (any attempts made by the first player P1 to activate the first control mechanism 104-1 during this time does not affect the readout displays 102). In this way, only the player making a move and completing his/her turn may activate a control mechanism 104 to pause/start the time decrementing of the readout displays 102.

In some embodiments, each control mechanism 104-1, 104-2 is portable and may be positioned by its respective player P1, P2 in any convenient location and in any convenient orientation as decided by its respective player P1, P2. Each control mechanism 104-1, 104-2 may be hardwired to the readout system 100, the timer system 200 and/or the controller 300, may be connected wirelessly to the readout system 100, the timer system 200 and/or the controller 300 (e.g., using Bluetooth, Wi-Fi or other wireless communication protocols), or any combination thereof. In other embodiments, the control mechanisms 104-1, 104-2 are configured with an associated readout 102.

Timer System 200

In one exemplary embodiment hereof, the timer system 200 generally controls each readout display 102.

The timer system 200 may include one or more processors 202 (herein referred to as processor 202) that may include all of the associated electrical and non-electrical components, devices and/or systems that may be required for each processor 202 to properly function and perform its defined operations. These may include chip sets, power supplies, circuit boards, capacitors, inductors, resistors, amplifiers and other components, devices and systems that may be required as known in the art. In addition, it should be understood that processor 202 may include microprocessors, microcontrollers, CPUs, computers, controllers or any other type or combination of types of devices that may perform the operations as defined in this description. Note also that processor 202 may be a unique processor 202 or set of processors 202, or may be a shared processor 202 or shared set of processors 202 that may also be utilized by other components or systems within system 10.

Processor 202 may also include a variety of software programs, applications, or scripts that may run on processor 202, and in some embodiments, processor 202 may include a library of preprogrammed functions that may be used alone or in conjunction with other software.

In addition, processor 202 may include memory that may be random access memory (RAM), read-only memory (ROM), hard drives, optical drives, CDs, DVDs, SD cards, USB memory sticks, or other types of memory. Memory may store said software and said received electrical signals (e.g., triggers from the control mechanism 104), as well as other information, data or other types of electronic media that may be utilized by the timer system 200.

In some embodiments, the timer system 200 controls each readout display 102-1, 102-2, 102-3, 102-4 to perform the functionalities as described above when the control mechanisms 104-1, 104-2 are activated. Accordingly, the timer system 200 senses when each control mechanism 104-1, 104-2 is triggered, and depending on which control mechanism 104-1, 104-2 is triggered and knowing which player's turn it is, pauses particular readout displays 102 from time decrementing and/or starts other readout displays 102 decrementing time and/or does nothing.

In one exemplary embodiment hereof as shown in FIG. 2, the timer system 200 includes one or more control mechanisms 204-1, 204-2, 204-3, . . . 204-n (collectively and individually 204). The control mechanisms 204 may include buttons, switches, knobs, levers, other types of control mechanisms and any combination thereof.

In some embodiments, a first control mechanism 204-1 is used to set the initial game time allotment for each player P1, P2 on each readout display 102. Using the example above, the first control mechanism 204-1 may be used to set the time of each readout display 102 to 15 minutes. The first control mechanism 204-1 may be used to increment and/or decrement the allotted time setting, and preferably sets all of the readout displays simultaneously. Preset time allotments may also be chosen and set by the first control mechanism 204-1.

In some embodiments, a second control mechanism 204-2 is used to choose the type of game format being played. For example, the second control mechanism 204-2 may set the timing system 200 to implement some of the following chess game formats (without limitation):
1. Slow tournament: 2 hours to reach move 40, then one extra hour to reach move 60, then 40 mins to finish (per player);
2. Quick tournament: 1 hour 30 mins to reach move 35, then 30 mins to finish (per player);
3. FIDE tournament: 1 hour 30 minutes to reach move 40, then 30 mins to finish, plus 30 seconds per move (per player);
4. Quickplay: 20, 30 or 40 minutes per player for all moves;
5. Blitz: 5 minutes per player for all moves;
6. Bullet: one minute per player for all moves;
7. Lightning: 10 seconds per move;
8. Hourglass: 1 to 2 mins for each player to start with time lost by each player added to the opponent's clock, and vice versa;
9. Fischer delay: 5 seconds (or less) added to a player's clock after his/her each move; and
10. Other types of chess game formats.

Once a game format is chosen using the second control mechanism 204-2, the timer system 200 may implement the format and control (set) each of the display readouts 102 accordingly. It is understood that the above list of chess game formats is meant for demonstration and the system 10 may implement chess formats of any kind. It is also understood that the scope of the system 10 is not limited in any way by the chess game formats that it may be used to implement.

In some embodiments, a third control mechanism 204-3 is used (activated) to start the beginning of the game, and accordingly, to start the time decrementing of one or more display readouts 102 (e.g., the first player's display readout 102-1 and its associated display readout 102-4).

Once a chess game has started (e.g., using the third control mechanism 204-3), the timer system 200 begins time decrementing the first and fourth display readouts 102-1, 102-4 until the first player P1 makes a move and subsequently activates the control mechanism 104-1 at which time the timer system 200 causes the first and fourth display readouts 102-1, 102-4 to pause and the third and second display readouts 102-3, 102-2 to decrement time. The third and second readouts 102-3, 102-2 continue to decrement time until the second player P2 makes a move and subsequently activates the control mechanism 104-2, at which time the timer system 200 causes the third and second display readouts 102-3, 102-2 to pause and the first and fourth display readouts 102-1, 102-4 to decrement time again. This process generally continues until either player P1, P2 wins the game or runs out of time.

In some embodiments, if a player P1, P2 activates his/her control mechanism 104 out of turn (e.g., during the time that their opposing player is making his/her move), the timer system 200 may provide a warning to the player P1, P2 that it is not their turn and that he/she must refrain from activating his/her control mechanism 104 out of turn. The warning may be in the form of an image or reading on one or more readout displays 102, an audio warning, a notification sent to a chess match official, other types of warnings and any combination thereof.

Controller 300

The controller 300 may include a computer, a smartphone, a tablet computer, a laptop, a personal computer, a hub, a server, a cloud platform, any other type of controller and any combination thereof.

In some embodiments, the controller 300 performs complementary and/or supportive operations in parallel with the timer system 200. For example, the controller 300 may perform some or all of the processing required by the timer system 200 to perform its functionalities. In this case, the timer system 200 may be in communication with the controller 300 such that the controller 300 may receive information from the timer system 200, perform operations on the information, and subsequently communicate processed information back to the timer system 200 for implementation. The communication between the controller 300 and the timer system 200 may be provided via hard wires, wireless communications, other types of communications and any combination thereof.

In other embodiments, the controller 300 performs operations to support the timer system 200, the overall system 10 and to provide additional functionalities. These operations may include functionalities such as (without limitation):
1. Identifying and providing information regarding each player P1, P2 (backgrounds, rankings, match histories, photographs, videos, etc.),
2. Keeping track of each chess match score;
3. Communicating any or all of the above information (or other information) to a cloud platform such that the information may be disseminated broadly (e.g., to mobile applications, websites, etc.); and
4. Other types of functionalities.

In any of the aforementioned embodiments or otherwise, system 10 may be (i) standalone and generally separate from the game assembly 400 (e.g., separate from a chess game board), (ii) may include some standalone elements and some elements integrated into the game assembly 400 (e.g., integrated into a chess game board), and/or (iii) fully integrated into a game board 400 (e.g., fully integrated into a chess game board).

In any of the above embodiments or otherwise, different elements of the system 10 may be electrically connected using hardwired transmission lines (e.g., wires, cables, etc.), may use wireless communication protocols (Bluetooth, Wi-Fi, telephony, etc.), other types of communication methods and any combination thereof. For example, the timer system 200 may communicate with the readout system 100 using Bluetooth communications technologies. In another example, the timer system 200 may be hard wired to the readout system 100. In another example, the controller 300 may communication with the timer system 200 using Bluetooth communications technologies and/or hardwired configurations.

Benefits of the System

The benefits of the system 10 are multifold and include, without limitation:

First, providing two dedicated readouts 102 on each side of the gameboard 400 for each player P1, P2 provides full frontal view of the readout displays 102 for each player P1, P2 and eliminates the necessity for the players P1, P2 to view the readout displays 102 from a side angle.

Second, by proving portable (positionable) control mechanisms 104, one for each player P1, P2, to pause/start each respective readout display 102, any advantage gained by either player P1, P2 due to the positioning of the control mechanisms 104 is eliminated.

Those of ordinary skill in the art will appreciate and understand, upon reading this description, that embodiments hereof may provide different and/or other advantages, and that not all embodiments or implementations need have all advantages.

Computing

The services, mechanisms, operations and acts shown and described above are implemented, at least in part, by software running on one or more computers or computer systems or devices. It should be appreciated that each user device is, or comprises, a computer system.

Programs that implement such methods (as well as other types of data) may be stored and transmitted using a variety of media (e.g., computer readable media) in a number of manners. Hard-wired circuitry or custom hardware may be used in place of, or in combination with, some or all of the software instructions that can implement the processes of various embodiments. Thus, various combinations of hardware and software may be used instead of software only.

One of ordinary skill in the art will readily appreciate and understand, upon reading this description, that the various processes described herein may be implemented by, e.g., appropriately programmed general purpose computers, special purpose computers and computing devices. One or more such computers or computing devices may be referred to as a computer system.

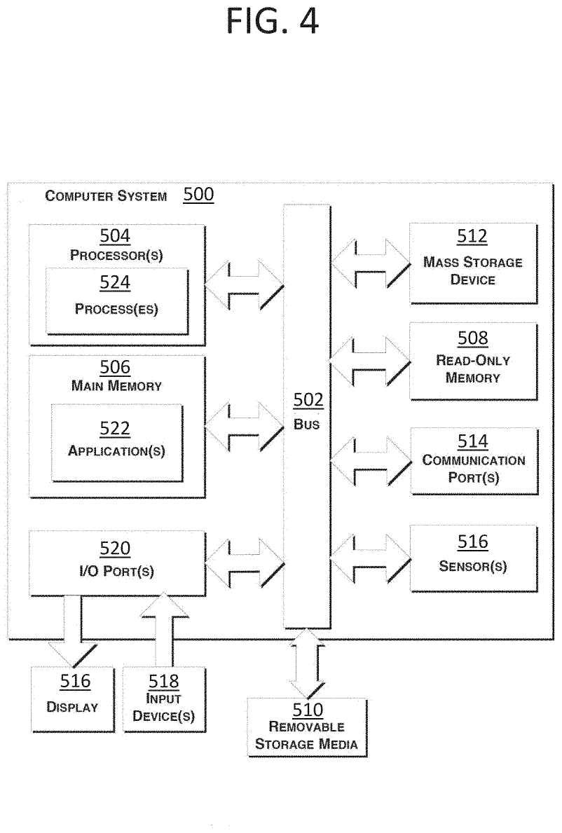

FIG. 4 is a schematic diagram of a computer system 500 upon which embodiments of the present disclosure may be implemented and carried out.

According to the present example, the computer system 600 includes a bus 502 (i.e., interconnect), one or more processors 504, one or more communications ports 514, a main memory 506, removable storage media 510, read-only memory 508, and a mass storage 512. Communication port(s) 514 may be connected to one or more networks by way of which the computer system 500 may receive and/or transmit data.

As used herein, a “processor” means one or more microprocessors, central processing units (CPUs), computing devices, microcontrollers, digital signal processors, or like devices or any combination thereof, regardless of their architecture. An apparatus that performs a process can include, e.g., a processor and those devices such as input devices and output devices that are appropriate to perform the process.

Processor(s) 504 can be (or include) any known processor, such as, but not limited to, an Intel® Itanium® or Itanium 2® processor(s), AMD® Opteron® or Athlon MP® processor(s), or Motorola® lines of processors, and the like. Communications port(s) 514 can be any of an RS-232 port for use with a modem-based dial-up connection, a 10/100 Ethernet port, a Gigabit port using copper or fiber, or a USB port, and the like. Communications port(s) 514 may be chosen depending on a network such as a Local Area Network (LAN), a Wide Area Network (WAN), a CDN, or any network to which the computer system 500 connects. The computer system 500 may be in communication with peripheral devices (e.g., display screen 516, input device(s) 518) via Input/Output (I/O) port 520. Some or all of the peripheral devices may be integrated into the computer system 500, and the input device(s) 518 may be integrated into the display screen 516 (e.g., in the case of a touch screen).

Main memory 506 can be Random Access Memory (RAM), or any other dynamic storage device(s) commonly known in the art. Read-only memory 508 can be any static storage device(s) such as Programmable Read-Only Memory (PROM) chips for storing static information such as instructions for processor(s) 504. Mass storage 512 can be used to store information and instructions. For example, hard disks such as the Adaptec® family of Small Computer Serial Interface (SCSI) drives, an optical disc, an array of disks such as Redundant Array of Independent Disks (RAID), such as the Adaptec® family of RAID drives, or any other mass storage devices may be used.

Bus 502 communicatively couples processor(s) 504 with the other memory, storage and communications blocks. Bus 502 can be a PCI/PCI-X, SCSI, a Universal Serial Bus (USB) based system bus (or other) depending on the storage devices used, and the like. Removable storage media 510 can be any kind of external hard-drives, floppy drives, IOMEGA® Zip Drives, Compact Disc-Read Only Memory (CD-ROM), Compact Disc-Re-Writable (CD-RW), Digital Versatile Disk-Read Only Memory (DVD-ROM), etc.

Embodiments herein may be provided as one or more computer program products, which may include a machine-readable medium having stored thereon instructions, which may be used to program a computer (or other electronic devices) to perform a process. As used herein, the term “machine-readable medium” refers to any medium, a plurality of the same, or a combination of different media, which participate in providing data (e.g., instructions, data structures) which may be read by a computer, a processor, or a like device. Such a medium may take many forms, including but not limited to, non-volatile media, volatile media, and transmission media. Non-volatile media include, for example, optical or magnetic disks and other persistent memory. Volatile media include dynamic random access memory, which typically constitutes the main memory of the computer. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications.

The machine-readable medium may include, but is not limited to, floppy diskettes, optical discs, CD-ROMs, magneto-optical disks, ROMs, RAMs, erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments herein may also be downloaded as a computer program product, wherein the program may be transferred from a remote computer to a requesting computer by way of data signals embodied in a carrier wave or other propagation medium via a communication link (e.g., modem or network connection).

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols; and/or (iv) encrypted in any of a variety of ways well known in the art.

A computer-readable medium can store (in any appropriate format) those program elements that are appropriate to perform the methods.

As shown, main memory 506 is encoded with application(s) 522 that support(s) the functionality as discussed herein (an application 522 may be an application that provides some or all of the functionality of one or more of the mechanisms described herein). Application(s) 522 (and/or other resources as described herein) can be embodied as software code such as data and/or logic instructions (e.g., code stored in the memory or on another computer readable medium such as a disk) that supports processing functionality according to different embodiments described herein.

During operation of one embodiment, processor(s) 504 accesses main memory 506 via the use of bus 502 in order to launch, run, execute, interpret or otherwise perform the logic instructions of the application(s) 522. Execution of application(s) 522 produces processing functionality of the service(s) or mechanism(s) related to the application(s). In other words, the process(es) 524 represents one or more portions of the application(s) 522 performing within or upon the processor(s) 504 in the computer system 500.

It should be noted that, in addition to the process(es) 524 that carries(carry) out operations as discussed herein, other embodiments herein include the application 522 itself (i.e., the un-executed or non-performing logic instructions and/or data). The application 522 may be stored on a computer readable medium (e.g., a repository) such as a disk or in an optical medium. According to other embodiments, the application 522 can also be stored in a memory type system such as in firmware, read only memory (ROM), or, as in this example, as executable code within the main memory 506 (e.g., within Random Access Memory or RAM). For example, application 522 may also be stored in removable storage media 510, read-only memory 508, and/or mass storage device 512.

Those skilled in the art will understand that the computer system 500 can include other processes and/or software and hardware components, such as an operating system that controls allocation and use of hardware resources.

As discussed herein, embodiments of the present invention include various steps or operations. A variety of these steps may be performed by hardware components or may be embodied in machine-executable instructions, which may be used to cause a general-purpose or special-purpose processor programmed with the instructions to perform the operations. Alternatively, the steps may be performed by a combination of hardware, software, and/or firmware. The term “module” refers to a self-contained functional component, which can include hardware, software, firmware or any combination thereof.

One of ordinary skill in the art will readily appreciate and understand, upon reading this description, that embodiments of an apparatus may include a computer/computing device operable to perform some (but not necessarily all) of the described process.

Embodiments of a computer-readable medium storing a program or data structure include a computer-readable medium storing a program that, when executed, can cause a processor to perform some (but not necessarily all) of the described process.

Where a process is described herein, those of ordinary skill in the art will appreciate that the process may operate without any user intervention. In another embodiment, the process includes some human intervention (e.g., a step is performed by or with the assistance of a human).

As used herein, including in the claims, the phrase “at least some” means “one or more,” and includes the case of only one. Thus, e.g., the phrase “at least some ABCs” means “one or more ABCs”, and includes the case of only one ABC.

As used herein, including in the claims, term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

As used in this description, the term “portion” means some or all. So, for example, “A portion of X” may include some of “X” or all of “X”. In the context of a conversation, the term “portion” means some or all of the conversation.

As used herein, including in the claims, the phrase “using” means “using at least,” and is not exclusive. Thus, e.g., the phrase “using X” means “using at least X.” Unless specifically stated by use of the word “only”, the phrase “using X” does not mean “using only X.”

As used herein, including in the claims, the phrase “based on” means “based in part on” or “based, at least in part, on,” and is not exclusive. Thus, e.g., the phrase “based on factor X” means “based in part on factor X” or “based, at least in part, on factor X.” Unless specifically stated by use of the word “only”, the phrase “based on X” does not mean “based only on X.”

In general, as used herein, including in the claims, unless the word “only” is specifically used in a phrase, it should not be read into that phrase.

As used herein, including in the claims, the phrase “distinct” means “at least partially distinct.” Unless specifically stated, distinct does not mean fully distinct. Thus, e.g., the phrase, “X is distinct from Y” means that “X is at least partially distinct from Y,” and does not mean that “X is fully distinct from Y.” Thus, as used herein, including in the claims, the phrase “X is distinct from Y” means that X differs from Y in at least some way.

It should be appreciated that the words “first,” “second,” and so on, in the description and claims, are used to distinguish or identify, and not to show a serial or numerical limitation. Similarly, letter labels (e.g., “(A)”, “(B)”, “(C)”, and so on, or “(a)”, “(b)”, and so on) and/or numbers (e.g., “(i)”, “(ii)”, and so on) are used to assist in readability and to help distinguish and/or identify, and are not intended to be otherwise limiting or to impose or imply any serial or numerical limitations or orderings. Similarly, words such as “particular,” “specific,” “certain,” and “given,” in the description and claims, if used, are to distinguish or identify, and are not intended to be otherwise limiting.

As used herein, including in the claims, the terms “multiple” and “plurality” mean “two or more,” and include the case of “two.” Thus, e.g., the phrase “multiple ABCs,” means “two or more ABCs,” and includes “two ABCs.” Similarly, e.g., the phrase “multiple PQRs,” means “two or more PQRs,” and includes “two PQRs.”

The present invention also covers the exact terms, features, values and ranges, etc. in case these terms, features, values and ranges etc. are used in conjunction with terms such as about, around, generally, substantially, essentially, at least etc. (i.e., “about 3” or “approximately 3” shall also cover exactly 3 or “substantially constant” shall also cover exactly constant).

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to”, and are not intended to exclude other components unless specifically so stated.

It will be appreciated that variations to the embodiments of the invention can be made while still falling within the scope of the invention. Alternative features serving the same, equivalent or similar purpose can replace features disclosed in the specification, unless stated otherwise. Thus, unless stated otherwise, each feature disclosed represents one example of a generic series of equivalent or similar features.

The present invention also covers the exact terms, features, values and ranges, etc. in case these terms, features, values and ranges etc. are used in conjunction with terms such as about, around, generally, substantially, essentially, at least etc. (i.e., “about 3” shall also cover exactly 3 or “substantially constant” shall also cover exactly constant).

Use of exemplary language, such as “for instance”, “such as”, “for example” (“e.g.,”) and the like, is merely intended to better illustrate the invention and does not indicate a limitation on the scope of the invention unless specifically so claimed.

While the invention has been described in connection with what is presently considered to be the most practical and preferred embodiments, it is to be understood that the invention is not to be limited to the disclosed embodiment, but on the contrary, is intended to cover various modifications and equivalent arrangements included within the spirit and scope of the appended claims.

I claim:

1. A timer system comprising:
a first readout, a second readout, a third readout and a fourth readout, the first and fourth readouts each displaying a first amount of time, and the second and third readouts each displaying a second amount of time;
a timer system configured with the first, second, third and fourth readouts;
a first control mechanism and a second control mechanism each configured with the timer system;
whereupon activation of the first control mechanism triggers the timer system to hold the first amount of time displayed on the first and fourth readouts static and to decrement the second amount of time displayed on the second and third readouts; and
whereupon activation of the second control mechanism triggers the timer system to hold the second amount of time displayed on the second and third readouts static and to decrement the first amount of time displayed on the first and fourth readouts.

2. The timer system of claim 1 wherein the decrementing of the second amount of time displayed on the second and third readouts triggered by the activation of the first control mechanism continues until a subsequent activation of the second control mechanism.

3. The timer system of claim 2 wherein the decrementing of the second amount of time displayed on the second and third readouts triggered by the activation of the first control mechanism includes decrementing the second amount of time in increments of seconds.

4. The timer system of claim 1 wherein the decrementing of the first amount of time displayed on the first and fourth readouts triggered by the activation of the second control mechanism continues until a subsequent activation of the second control mechanism.

5. The timer system of claim 4 wherein the decrementing of the first amount of time displayed on the first and fourth readouts triggered by the activation of the second control mechanism includes decrementing the first amount of time in increments of seconds.

6. The timer system of claim 1 further comprising a game board.

7. The timer system of claim 6 wherein the type of game board is selected from the group: chess, checkers, and backgammon.

8. The game timer system of claim 1 further comprising a third control mechanism configured with the timer system and adapted to set the first amount of time displayed on the first and fourth readouts and the second amount to time displayed on second and third readouts to the same amount of time.

9. The timer system of claim 1 wherein the first amount of time and the second amount of time each include hours, minutes and seconds.

10. The timer system of claim 1 wherein the first control mechanism includes a first button and/or the second control mechanism includes a second button.

11. The timer system of claim 1 wherein the first, second, third and/or fourth readouts are digital readouts.

12. A game timer system for use by a first player of a two-person game and a second player of the two-person game, the game timer system comprising:
a first readout, a second readout, a third readout and a fourth readout, the first and fourth readouts adapted for use by the first player and each displaying a first amount of time, and the second and third readouts adapted for use by the second player and each displaying a second amount of time;
a timer system configured with the first, second, third and fourth readouts;
a first control mechanism adapted for use by the first player and a second control mechanism adapted for use by the second player, the first and second control mechanisms each configured with the timer system;
whereupon activation of the first control mechanism by the first player triggers the timer system to hold the first amount of time displayed on the first and fourth readouts static and to decrement the second amount of time displayed on the second and third readouts; and
whereupon activation of the second control mechanism by the second player triggers the timer system to hold the second amount of time displayed on the second and third readouts static and to decrement the first amount of time displayed on the first and fourth readouts.

13. The timer system of claim 12 wherein the decrementing of the second amount of time displayed on the second and third readouts triggered by the activation of the first control mechanism continues until a subsequent activation of the second control mechanism.

14. The timer system of claim 13 wherein the decrementing of the second amount of time displayed on the second and third readouts triggered by the activation of the first control mechanism includes decrementing the second amount of time in increments of seconds.

15. The timer system of claim 12 wherein the decrementing of the first amount of time displayed on the first and fourth readouts triggered by the activation of the second control mechanism continues until a subsequent activation of the second control mechanism.

16. The timer system of claim 15 wherein the decrementing of the first amount of time displayed on the first and fourth readouts triggered by the activation of the second control mechanism includes decrementing the first amount of time in increments of seconds.

17. The timer system of claim 12 further comprising a game board selected from the group: chess, checkers, and backgammon.

18. The game timer system of claim 12 further comprising a third control mechanism configured with the timer system and adapted to set the first amount of time displayed on the first and fourth readouts and the second amount to time displayed on second and third readouts to the same amount of time.

19. The timer system of claim 12 wherein the first control mechanism includes a first button and/or the second control mechanism includes a second button.

20. The timer system of claim 12 wherein the first, second, third and/or fourth readouts are digital readouts that display hours, minutes and seconds.
